(19) United States
(12) Patent Application Publication
(10) Pub. No.: US 2018/0215665 A1
(43) Pub. Date: Aug. 2, 2018

(54) ENCAPSULATED AGENT AND CONSTRUCTIONAL OBJECT

(71) Applicant: ADEKA CORPORATION, Tokyo (JP)

(72) Inventors: Kazuyuki NODA, Tokyo (JP); Masatoshi HOMMA, Tokyo (JP); Kensaku AKIMOTO, Tokyo (JP); Hirokatsu SHINANO, Tokyo (JP)

(73) Assignee: ADEKA CORPORATION, Tokyo (JP)

(21) Appl. No.: 15/755,154

(22) PCT Filed: Aug. 26, 2016
(86) PCT No.: PCT/JP2016/074986

§ 371 Date: Feb. 26, 2018

(30) Foreign Application Priority Data
Aug. 26, 2015 (JP) 2015-167126

(51) Int. Cl. C04B 20/10

(52) U.S. Cl. CPC C04B 20/1037; C04B 2103/0051; C04B 20/1033

(57) ABSTRACT

An encapsulated agent includes a central part and an outer part that covers a surface of the central part. The central part contains a material that is expansive with respect to a liquid, and the outer part contains a material that is able to induce expansion of the central part with respect to the liquid.

### TECHNICAL FIELD

The invention relates to an encapsulated agent that exercises a function utilizing expansibility with respect to a liquid, and to a constructional object that uses the encapsulated agent.

### BACKGROUND ART

A material that exercises a predetermined function utilizing the expansibility with respect to a liquid has been known, and such a material has been utilized in a diversity of fields.

For example, in the civil engineering and construction field, a cement composition containing bentonite has been used to prevent occurrence of a crack, etc. prior to curing of mortar or concrete (for example, see PTL 1). The bentonite is a material that expands (swells) significantly by absorbing water.

Further, in the event of occurrence of the above-described crack, a resin material has been embedded into the crack for repairing (for example, see PTL 2).

### CITATION LIST

### Patent Literature

[PTL 1] Japanese Unexamined Patent Application Publication No. H07-053248

[PTL 2] Japanese Unexamined Patent Application Publication No. 2013-087596

### SUMMARY OF THE INVENTION

In a diversity of fields, a material that exercises a predetermined function utilizing the expansibility with respect to a liquid has been used; however, there is still room for improvement for effective use of the function of the material.

It is therefore desirable to provide an encapsulated agent and a constructional object that are able to effectively exercise a function utilizing expansibility with respect to a liquid.

As a result of considerations with a concentrated mind to accomplish the above-described objective, the investors have found that the above-described problem is solved by covering a material that is expansive with respect to a liquid by the use of a material with a capability to induce expansion with respect to the liquid.

The invention is achieved on the basis of the above-described findings. An encapsulated agent according to an embodiment of the invention includes: a central part containing a material that is expansive with respect to a liquid; and an outer part that covers a surface of the central part, and contains a material with a capability to induce expansion of the central part with respect to the liquid.

A constructional object according to an embodiment of the invention includes a constructional material and one or more encapsulated agents. Each of the one or more encapsulated agents includes a central part and an outer part. The central part contains a material that is expansive with respect to a liquid. The outer part covers a surface of the central part, and contains a material with a capability to induce expansion of the central part with respect to the liquid.

Here, the “material that is expansive with respect to a liquid” is a material having a property of being self-expansive with respect to a liquid. In other words, the material described here is a material that is able to increase its own volume owing to contact with a liquid.

Further, the “material with a capability to induce expansion of the central part with respect to the liquid” is a material with a capability to induce expansion of the material that is expansive with respect to a liquid, while covering the material that is expansive with respect to the liquid, by utilizing some sort of phenomenon (cause) that the outer part gets involved in. The phenomenon that induces the expansion is not specifically limited; however, includes one or more kinds of expansion, fusion (melting), cracking (cleavage), deformation, swelling, dissolution, and dispersion into a liquid, etc. that are caused by heat, friction, pressure, and contact with the liquid, etc., for example.

According to the encapsulated agent of the embodiment of the invention, the central part contains the material that is expansive with respect to a liquid, and the outer part that covers the central part contains the material with the capability to induce expansion of the central part with respect to the liquid. This makes it possible to effectively exercise the function utilizing the expansibility with respect to the liquid.

According to the constructional object of the invention, the constructional object includes the constructional material, and the one or more encapsulated agents each having a configuration similar to that of the above-described encapsulated agent of the invention. This makes it possible to effectively exercise the function of the encapsulated agent utilizing the expansibility with respect to the liquid.

### BRIEF DESCRIPTION OF DRAWINGS

FIG. 1 is a cross-sectional view of a configuration of an encapsulated agent according to an embodiment of the invention.

FIG. 2 is a cross-sectional view of another configuration of the encapsulated agent according to the embodiment of the invention.

FIG. 3 is a cross-sectional view intended to explain a function of the encapsulated agent.

FIG. 4 is a cross-sectional view of a configuration of a constructional object using the encapsulated agent according to the embodiment of the invention.

FIG. 5 is a cross-sectional view intended to explain a function of the constructional object.

FIG. 6 is a cross-sectional view intended to explain the function of the constructional object following on FIG. 5.

FIG. 7 is a diagram illustrating a correlation between a weight increase ratio of the encapsulated agent, etc. and an elapsed time.

### MODES FOR CARRYING OUT THE INVENTION

Hereinafter, embodiments of the invention are described in detail. The order of descriptions is as follows. However, the details concerning the invention are not limited to the embodiments described below, and may be modified as appropriate.

### 1. Encapsulated Agent

1-1. Configuration

1-2. Function

1-3. Manufacturing Method

1-4. Workings and Effects

### 2. Application of Encapsulated Agent (Constructional Object)

2-1. Configuration

2-2. Function

2-3. Workings and Effects

### [1. Encapsulated Agent]

The description is provided of an encapsulated agent according to an embodiment of the invention.

The encapsulated agent described here is a repairing agent having a function of repairing breakage of some sort of a constructional object through the use in a state of being contained in the constructional object. This ensures that the constructional object in which the encapsulated agent is contained has a so-called self-repairing function utilizing a repairing function of the encapsulated agent.

The above-described “constructional object” is an object that necessitates to be maintained in a state of avoiding excessive deterioration in the physical characteristics thereof after manufacturing for some purpose or other, and the physical characteristics thereof include, for example, a shape, a strength, etc.

The “breakage of the constructional object” means occurrence of cracking (small crack, etc.) or any other cracked condition in the vicinity of a surface of the constructional object due to internal stress and/or external stress, for example. The physical characteristics of the constructional object deteriorate due to the breakage, and therefore it is necessitated that the constructional object is repaired with use of the encapsulated agent, as described above.

It is to be noted that the self-repairing function of the constructional object in which the encapsulated agent is contained is described in detail in “2. Application of Encapsulated Agent” to be described later.

The one or more encapsulated agents are contained in the constructional object. Accordingly, in a case where the plurality of encapsulated agents are contained in the constructional object, the plurality of encapsulated agents are preferably dispersed in the constructional object. This is because it is easy for the encapsulated agents to exercise the repairing function without depending on a breakage position of the constructional object. In other words, when the plurality of encapsulated agents are disposed to be dispersed in the constructional object, this increases a possibility of being able to utilize the repairing function of the encapsulated agents even if the constructional object is broken at any position.

The application of the encapsulated agent is not specifically limited as long as the application necessitates repairing of breakage in the middle of use of the constructional object after manufacturing of the constructional object. The application of the encapsulated agent is mainly determined depending on the intended use, etc. of the constructional object.

To cite a case, the encapsulated agent is used in the construction application, the shore protection work application, etc. In such a case, the encapsulated agent is contained in a constructional material to be used for manufacturing of the constructional object, as described later. This ensures that the constructional object with the encapsulated agent contained in the constructional material thereof has the self-repairing function utilizing a repairing function of the encapsulated agent, as described above.

### [1-1. Configuration]

First, the description is provided of a configuration of the encapsulated agent.

FIG. 1 illustrates a cross-sectional configuration of the encapsulated agent. The encapsulated agent includes a central part 1 and an outer part 2. In other words, the encapsulated agent has a structure (a capsule structure) in which a main body (the central part 1) that exercises a repairing function substantially is provided inside a hollow structure (the outer part 2).

A shape of the encapsulated agent is not specifically limited, and the encapsulated agent takes a spherical shape, a plate-like shape, a massive shape, etc., for example. FIG. 1 illustrates a case where the encapsulated agent takes the spherical shape, for example.

Dimensions of the encapsulated agent are not specifically limited. For example, in a case where the encapsulated agent takes the spherical shape, an average particle size (a volumetric average particle size) of the encapsulated agent is within the range of about 50 μm to about 50 mm.

### [Central Part]

The central part 1 is a so-called core of the encapsulated agent, and contains one or more kinds of materials each of which is expansive with respect to a liquid (hereinafter called an “expansive material”).

As described above, the “expansive material” is a material having a property of being self-expansive with respect to a liquid, and more specifically, is a material that is able to increase its own volume as a result of contact with a liquid. At the time of use of the encapsulated agent, as described later, the outer part 2 induces expansion of the central part 1 (the expansive material) with respect to a liquid, which makes the expansive material expansible. As a result, the repairing function of the encapsulated agent is exercised utilizing the expansion phenomenon of the expansive material.

A kind of the above-described liquid is not specifically limited as long as the liquid is one or more kinds of liquids that are able to make the expansive material expansible. The kind of the liquid is mainly determined depending on the intended use, etc. of the constructional object in which the encapsulated agent is contained.

To cite a case, a liquid in a case where the encapsulated agent is contained in the constructional object to be used for the construction application, the shore protection work application, etc. is water, etc., for example. The “water” described here is, for example, the water that is likely to come in contact with the constructional object, and is specifically, rainwater, seawater, etc. In such a case, the expansive material expands with respect to the water, for example.

The reason (the technical principle) for which the expansive material expands is not specifically limited. In other words, the expansive material may be a material that absorbs the liquid (a liquid-absorbing material), a material that chemically reacts to the liquid (a reactive material), a material that utilizes a phenomenon other than the above, or a mixture of two or more kinds of any of those materials.

The liquid-absorbing material expands (swells) as a result of absorption of a liquid, and therefore a volume of the liquid-absorbing material increases as compared with that in a state prior to absorption of the liquid.

The reactive material expands as a result of a chemical reaction with a liquid, and therefore a volume of the reactive material increases as compared with a state prior to the chemical reaction with the liquid. A kind of the chemical reaction that induces the expansion is not specifically limited; however, includes a foam reaction, a hydration reaction, etc., for example.

In particular, the expansive material is preferably the liquid-absorbing material. This is because a volume of the expansive material increases sufficiently utilizing a simple liquid-absorbing phenomenon. Further, this is because, with the help of non-use of the chemical reaction, the encapsulated agent and the constructional object are not affected by the chemical reaction.

A kind of the liquid-absorbing material is not specifically limited as long as the liquid-absorbing material is a material that is expansible as a result of absorption of a liquid. Here, to cite an example case where the liquid is water, the liquid-absorbing material (water-absorbing material) that expands as a result of absorption of the water contains a liquid-absorbing (water-expansive) clay, a water-absorbing polymer compound, etc., for example.

The water-absorbing clay is, for example, a bentonite, etc. The bentonite is a general term for the clay that contains montmorillonite as a main constituent. A kind of the bentonite is not specifically limited; however, includes Na-type bentonite (sodium bentonite), Ca-type bentonite (calcium bentonite), etc., for example.

Examples of the water-absorbing polymer compound include a polyalkylene oxide, a polyacrylic acid, a polyacrylamide, polyvinyl alcohol, a polysaccharide, a water-expansive rubber, a starch, a cellulose, a maleic anhydride, a polysulfonic acid, a polyaspartic acid, a polyglutamic acid, a polyalgin acid, a salt of any of those compounds, etc. The polyalkylene oxide is, for example, a polyethylene oxide, etc. Further, the polysaccharide is, for example, a guar gum, a diutan gum, etc. It is to be noted that the water-absorbing polymer compound may be a copolymer of one or more kinds of a series of the above-described candidates for the water-absorbing polymer compound, and one or more kinds of polymer compounds other than the above.

In particular, the water-absorbing material is preferably the bentonite. Firstly, this is because the bentonite has the significantly-high affinity for water. With such an advantage, the bentonite is able to absorb the water with a weight several times as much as its own dry weight, resulting in a significant increase in a volume of the bentonite as a result of absorption of the water. Secondly, this is because the bentonite has the high thermal stability. With such an advantage, the bentonite is unlikely to deteriorate thermally even if it is used in a high-temperature environment. Thirdly, this is because the bentonite has the high viscosity and adhesive property at the time of water absorption. With such an advantage, it is easy for the bentonite to be attached (fixed) to a surface, etc. of the constructional object in which the encapsulated agent is contained in a state of being expansive as a result of absorption of the water.

It is to be noted that a shape of the central part 1 is not specifically limited, and the central part 1 takes a spherical shape, a plate-like shape, a massive shape, etc., for example. FIG. 1 illustrates a case where the central part 1 takes the spherical shape, for example.

Dimensions of the central part 1 are not specifically limited. For example, in a case where the central part 1 takes the spherical shape, an average particle size (a volumetric average particle size) of the central part 1 is within the range of about 10 μm to about 30 mm.

### [Outer Part]

The outer part 2 is a so-called shell of the encapsulated agent, and covers a surface of the central part 1. It is to be noted that the outer part 2 may employ a single-layer or multi-layer configuration.

As described above, preferably, the outer part 2 covers a whole surface of the central part 1 to provide the central part 1 inside a hollow structure thereof. In other words, preferably, the central part 1 is not exposed because it is completely covered with the outer part 2. This is because a repairing function of the encapsulated agent is first exercised only in the middle of use (at the time of breakage) of the constructional object in which the encapsulated agent is contained after the start of manufacturing of the constructional object, which makes it possible to optimize the timing when the repairing function is utilized. The detailed reason for this is as follows.

Hereinafter, for simplicity of explanation, a period of time in which the constructional object containing the encapsulated agent is not yet broken after the start of manufacturing of the constructional object, that is, a period of time from the start time of manufacturing of the constructional object to the time of occurrence of breakage through the start time of use of the constructional object is referred to as a “pre-breakage period of time”. Further, a period of time after breakage of the constructional object is referred to as a “post-breakage period of time”.

In other words, the “pre-breakage period of time” is a period of time in which the expansive material is not substantially expansible because an initial state (immediately after manufacturing of the encapsulated agent) of covering by the outer part 2 is almost maintained, and resultantly the outer part 2 does not yet induce expansion of the central part 1 (the expansive material) with respect to a liquid. Therefore, during the pre-breakage period of time, the encapsulated agent is unable to exercise the repairing function utilizing the expansion of the expansive material.

In contrast, the “post-breakage period of time” is a period of time in which the expansive material is substantially expansible because the outer part 2 induces expansion of the central part 1 (the expansive material) with respect to a liquid as a result of a change in a state of covering by the outer part 2. Therefore, during the post-breakage period of time, the encapsulated agent is able to exercise the repairing function utilizing the expansion of the expansive material.

As described later, in a case where a constructional object containing the encapsulated agent is used after manufacturing thereof, it is desirable to bring out the repairing function of the encapsulated agent first only at the time of breakage of the constructional object after manufacturing (during the post-breakage period of time), not to bring out the repairing function of the encapsulated agent immediately from a manufacturing state of the constructional object (during the pre-breakage period of time). This is because, for example, in a case where the encapsulated agent is used to repair breakage of the constructional object, it is meaningless that the encapsulated agent has already exercised the repairing function during the pre-breakage period of time even if there is a possibility that the encapsulated agent will come in contact with a liquid during both of the pre-breakage period of time and the post-breakage period of time, and the encapsulated agent has to exercise the repairing function first only during the post-breakage period of time.

Specifically, concrete is taken as an example of a constructional material to be used for manufacturing a constructional object. For manufacturing of the concrete, for example, a cement liquid (a ready-mixed concrete) in which the cement, etc. are dissolved and dispersed using water, etc. is prepared, and thereafter the cement liquid is solidified (cured). In such a case, to manufacture the concrete in which the encapsulated agent is finally contained, it is necessary to prepare the cement liquid in which the encapsulated agent is contained preliminarily.

In a case where the whole surface of the central part 1 is not covered with the outer part 2, a portion of the central part 1 has been already exposed in a preparatory stage of the cement liquid. In such a case, if the expansive material has a water-absorbing property, the expansive material absorbs water in the middle of a preparatory process and use of the cement liquid (during the pre-breakage period of time), and therefore the expansive material has already expanded during the pre-breakage period of time. As a result, the encapsulated agent exercises the repairing function unintentionally not during use of the concrete but even in the course of manufacturing thereof, which makes it impossible to utilize the repairing function of the encapsulated agent in the event of breakage of the concrete (during the post-breakage period of time). Far from it, the expansive material expands in the cement liquid, which makes it difficult in itself to manufacture the concrete with use of the cement liquid.

In contrast, in a case where the whole surface of the central part 1 is covered with the outer part 2, the central part 1 is not yet exposed in the preparatory stage of the cement liquid. In such a case, even if the expansive material has the water-absorbing property, the expansive material absorbs no water in the middle of the preparatory process and use of the cement liquid (during the pre-breakage period of time), which prevents the expansive material from expanding unintentionally during the pre-breakage period of time. This makes it possible to maintain the repairing function of the encapsulate agent during a period of time (the pre-breakage period of time) from the start of manufacturing of the concrete using the cement liquid to breakage of the concrete. In such a case, even if the encapsulated agent is contained in the cement liquid, the expansive material does not yet expand in the cement liquid, which allows the concrete to be manufactured without any issues using the cement liquid.

In addition, after the start of use of the concrete, when the encapsulated agent comes in contact with rainwater, etc. as a result of breakage of the concrete, the outer part 2 induces expansion of the expansive material by utilizing a phenomenon that is caused as a result of contact of the encapsulated agent with the rainwater, etc. Here, for example, after the start of use of the concrete, if the outer part 2 dissolves or swells in the event of breakage of the concrete (during the post-breakage period of time), the expansive material comes in contact with water for the first time, resulting in expansion of the expansive material. This makes it possible to utilize the repairing function of the encapsulated agent in the event of breakage of the concrete.

With all these factors, when the whole surface of the central part 1 is covered with the outer part 2, even if the encapsulated agent is contained in the cement liquid, it is possible to utilize the repairing function of the encapsulated agent in the proper timing, that is, at the time of breakage of the concrete, without impeding a manufacturing process of the concrete with use of the cement liquid.

Accordingly, the outer part 2 contains one or more kinds of materials that are able to induce expansion of the central part 1 (the expansive material) with respect to a liquid (such a material is hereinafter referred to as an “expansion-inducing material”).

As described above, the “expansion-inducing material” is a material that is able to induce (control) expansion of the expansive material with respect to a liquid while covering the expansive material, by utilizing some sort of phenomenon (cause) that the outer part 2 gets involved in.

It is to be noted that, after the expansion-inducing material induces expansion of the expansive material with respect to a liquid, a state of covering by the outer part 2 is not limited specifically. In other words, because the outer part 2 still covers the whole surface of the central part 1, the central part 1 may not be exposed. As an alternative, the outer part 2 covers only a portion of the surface of the central part 1, and therefore the central part 1 may be partly exposed. Or, the outer part 2 disappears completely, and therefore the whole surface of the central part 1 may be exposed.

A kind of the expansion-inducing material is not specifically limited as long as such a material is a material that is able to induce expansion of the expansive material with respect to a liquid. A kind of phenomenon that the expansion-inducing material utilizes to induce expansion of the expansive material (such a phenomenon is hereinafter referred to as an “expansion-inducing phenomenon”) is not specifically limited, and such a phenomenon may include a physical phenomenon, a chemical phenomenon, or both of those phenomena. Specifically, the expansion-inducing phenomenon includes, for example, one or more kinds of any state variations caused as a result of any external sources. “Any external sources” refer to, for example, heat, friction, pressure, and contact with a liquid (for example, water or any other liquid), etc. “Any state variations” refer to expansion, fusion (melting), cracking (cleavage), deformation, cleavage, swelling, dissolution, dispersion into a liquid, etc.

The expansion-inducing material includes, for example, one or more kinds of polymer compounds (resin materials) that are able to induce expansion of the expansive material with respect to a liquid. The polymer compound may be natural resin, synthetic resin, or both of those resin materials.

Specific examples of the expansion-inducing material include a copolymer of styrene and butadiene (SBR resin), a copolymer of acrylonitrile, butadiene, and styrene (ABS resin), a copolymer of acrylonitrile and styrene (AS resin), polyethylene, polypropylene, polystyrene, a polyalkylene oxide, polyalkylene glycol, polyvinyl alcohol, vinyl chloride resin, methacyl resin, acrylic resin, polyacrylamide, polyamide, polycarbonate, polyacetal, polyester, polyphenylene ether, phenol resin, epoxy resin, melamine resin, urea resin, alkyd resin, polyurethane resin, polytetrafluoroethylene (PTFE), a copolymer of tetrafluoroethylene and perfluoroalkyl vinyl ether (PFA), a copolymer of tetrafluoroethylene and hexafluoropropylene (FEP), a copolymer of tetrafluoroethylene and ethylene (ETFE), polyvinylidene fluoride (PVDF), polychlorotrifluoroethylene (PCTFE), a copolymer of chlorotrifluoroethylene and ethylene (ECTFE), silicone resin, polydimethylsiloxane, a modified substance of any of the above materials, etc. In a case where a polymer compound of the same kind is used as each of the expansive material and the expansion-inducing material, for example, a difference may be made in a physical property, etc. of each of the polymer compounds. The physical property includes, for example, one or more kinds of a molecular weight, a hydrophilic property, etc.

It is to be noted that, with the emphasis on the above-described role of the outer part 2, desirably, the outer part 2 mainly has four properties to be described below.

Firstly, in a case where, for manufacturing of a constructional object, a solution containing raw materials, etc. of the constructional object is used, the outer part 2 desirably keeps protecting the central part 1 even if the encapsulated agent is contained in the solution. This is because unintentional expansion of the expansive material is prevented by protecting the central part 1 with use of the outer part 2 during the pre-breakage period of time. The “solution” described here is, for example, the above-described cement liquid, etc.

Secondly, desirably, the outer part 2 induces sufficiently expansion of the central part 1 (the expansive material) with respect to a liquid in the event of breakage of the constructional object. This is because the central part 1 (the expansive material) is made to be expansive intentionally and positively during the post-breakage period of time.

Thirdly, a degree (for example, the induction speed, etc.) to which the outer part 2 induces expansion of the central part 1 with respect to a liquid is desirably easy to be controlled depending on one or more kinds of conditions including temperature of the liquid, etc. This is because, depending on the kind of the expansion-inducing phenomenon, the induction speed, etc. of the outer part 2 are easily affected by the temperature, etc. of the liquid. It is to be noted that, in some cases, the time necessary for induction by the outer part 2 may be influenced by a formation material, an average thickness, etc. of the outer part 2, for example.

Fourthly, after induction of expansion of the central part 1 with respect to a liquid, the outer part 2 is desirably unlikely to impede the expansion phenomenon of the expansive material. This is because, if the expansion phenomenon of the expansive material is impeded, breakage of the constructional object is unlikely to be repaired during the post-breakage period of time.

It is to be noted that the average thickness of the outer part 2 is not specifically limited; however, is within the range of about 10 μm to about 200 μm, for example. The “average thickness” described here refers to, for example, an average value of the thicknesses of the outer part 2 that are measured at any ten positions after a cross-sectional surface of the encapsulated agent is observed with use of a microscope. A kind of the microscope is not specifically limited; however, includes one or more kinds of a scanning electron microscope (SEM), etc., for example.

### [Other Materials]

It is to be noted that the outer part 2 may further include one or more kinds of other materials.

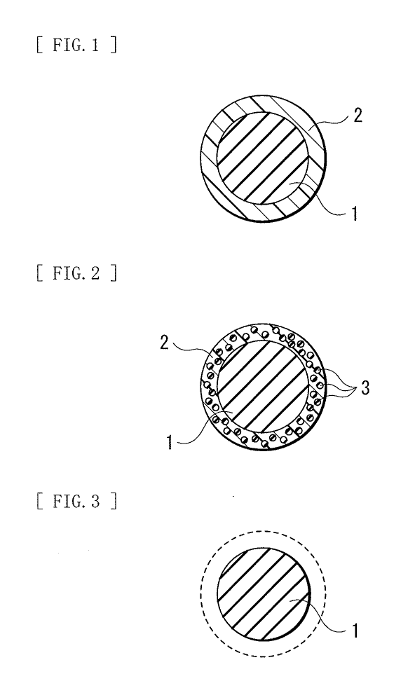

FIG. 2 illustrates another cross-sectional configuration of the encapsulated agent, and corresponds to FIG. 1. The other materials include, for example, one or more kinds of a plurality of particulate substances 3. This is because, in a process of manufacturing of the encapsulated agent (formation of the outer part 2), aggregation of particles with each other in the middle of granulation is suppressed. In a case where the outer part 2 includes the plurality of particulate substances 3, for example, the plurality of particulate substances 3 are dispersed in the expansion-inducing material, and therefore a dispersion state of the plurality of particulate substances 3 is maintained by the expansion-inducing material.

The plurality of particulate substances 3 are so-called fillers, and contain one or more kinds of an inorganic material, etc. for example. Examples of the inorganic material include a silicon oxide, talc, an aluminum oxide, a zeolite, etc. In particular, the silicon oxide and the talc are preferable. This is because the particles in the middle of granulation are less likely to be aggregated with one another. The plurality of particulate substances 3 are preferably dispersed in the outer part 2, for example.

It is to be noted that the shape of the plurality of particulate substances 3 is not specifically limited; however, includes one or more kinds of spherical, plate-like, massive shapes, etc. FIG. 2 illustrates a case where the plurality of particulate substances 3 take the spherical shapes, for example.

Dimensions of the plurality of particulate substances 3 are not limited specifically. For example, in a case where the plurality of particulate substances 3 take the spherical shapes, an average particle size (a volumetric average particle size) of each of the plurality of particulate substances 3 is within the range of about 0.1 μm to about 100 μm.

The content of the plurality of particulate substances 3 in the outer part 2 is not specifically limited; however, is preferably not excessively great. Specifically, the content of the plurality of particulate substances 3 in the outer part 2 is, for example, within the range of about 10 wt % to about 30 wt %. This is because, if the content of the plurality of particulate substances 3 is excessively great, there is a possibility that the dissolution speed, the swelling speed, etc. of the outer part 2 will suffer adverse effect.

Further, the other materials include, for example, a variety of additive agents, etc. Examples of the additive agent include a film-forming auxiliary agent, an anti-blocking agent, a coloring material, an antioxidant, a stabilizer, etc. The film-forming auxiliary agent mainly serves to control resin-film formation. The anti-blocking material has a function of suppressing aggregation of the encapsulated agents with each other (an anti-blocking function). The coloring material mainly serves to adjust a color tone of the encapsulated agent, and includes, for example, one or more kinds of a pigment, a colorant, etc. The antioxidant mainly serves to improve the preservation stability of the encapsulated agent. The stabilizer includes, for example, an ultraviolet absorbing agent, etc.

### [1-2. Function]

The encapsulated agent functions as follows in a manner of being used in a state of being included in a constructional object. Here, for example, the description is provided of the function of the encapsulated agent illustrated in FIG. 1. FIG. 3 illustrates a cross-sectional configuration corresponding to FIG. 1 to explain the function of the encapsulated agent.

During the pre-breakage period of time, the central part 1 (the expansive material) is covered with the outer part 2, as illustrated in FIG. 1. In such a case, because the outer part 2 (the expansion-inducing material) is unable to induce expansion of the expansive material with respect to a liquid, the expansive material does not yet expand. As a result, the repairing function of the encapsulated agent is maintained.

It is to be noted that, for example, in a case where the expansion-inducing phenomenon is dissolution or swelling, when a solution is used for manufacturing of a constructional object, even if there is a possibility that the encapsulated agent will come in contact with a liquid (a solvent of the solution) in the solution, the outer part 2 does not dissolve or swell until the central part 1 actually comes in contact with the liquid if a duration of contact between the encapsulated agent and the liquid is short. As a result, because the expansive material does not yet expand, the repairing function of the encapsulated agent is maintained. In addition, even if the encapsulated agent is contained in the solution, the encapsulated agent has no adverse influence on a manufacturing process of the constructional object using the solution.

During the post-breakage period of time, because the outer part 2 is able to induce expansion of the expansive material with respect to a liquid, the expansive material becomes expansible. For example, in a case where the expansion-inducing phenomenon is dissolution or swelling, if the encapsulated agent comes in contact with the liquid, and a duration of contact between the encapsulated agent and the liquid becomes sufficiently long during the post-breakage period of time, a portion or a whole of the outer part 2 (the expansion-inducing material) dissolves or swells, resulting in contact between the central part 1 (the expansive material) and the liquid. FIG. 3 illustrates a case where the whole outer part 2 dissolves, for example. As a result, because the expansive material expands, the repairing function of the encapsulated agent is exercised. Therefore, breakage of the constructional object is repaired utilizing the repairing function of the encapsulated agent.

It is to be noted that a period of time necessitated until the encapsulated agent exercises the repairing function after the breakage of the constructional object depends on, for example, a degree to which the outer part 2 induces expansion of the expansive material with respect to a liquid, as described above. Therefore, such a period of time is determined depending on one or more kinds of conditions including temperature of the liquid, etc. This is because these conditions influence the induction speed, etc. of the outer part 2.

### [1-3. Manufacturing Method]

The above-described encapsulated agent is manufactured in the following procedures, for example.

It is to be noted that formation materials of a series of the component parts of the encapsulated agent have been described in detail, and therefore the relevant descriptions are hereinafter omitted as appropriate.

First, the central part 1 containing the expansive material, and a processing solution to be used for formation of the outer part 2 are prepared.

In preparing the processing solution, for example, an expansion-inducing material, a solvent for dissolving the expansion-inducing material, and, on an as-needed basis, the plurality of particulate substances 3, etc. are mixed, and thereafter the mixture is stirred. As a result, the expansion-inducing material is dissolved in the solvent, or the expansion-inducing material is dispersed in the solvent to achieve an emulsion, leading to obtainment of the processing solution. The solvent includes, for example, one or more kinds of an aqueous solvent, an organic solvent, etc., and is determined depending on a kind of the expansion-inducing material, etc. The aqueous solvent is, for example, water, alcohol, etc. Examples of the organic solvent include toluene, styrene, ethyl acetate, butyl acetate, hexane, etc.

Next, the processing solution is supplied to a surface of the central part 1, and thereafter the processing solution is dried. As a result, the outer part 2 containing the expansion-inducing material is formed in a manner of covering the surface of the central part 1. In this case, a process of forming the outer part 2 may be repeated two times or more.

It is to be noted that, in using the plurality of particulate substances 3, the plurality of particulate substances 3 may be contained in the processing solution, or the plurality of particulate substances 3 may not be contained in the processing solution. In the former case, for example, after the plurality of particulate substances 3 are dispersed in the processing solution, the processing solution is supplied to the surface of the central part 1. In the latter case, for example, in a process where the processing solution in which the plurality of particulate substances 3 are not dispersed is supplied to the surface of the central part 1, the plurality of particulate substances 3 are put in the processing solution separately. The number of times of putting the plurality of particulate substances 3 in the processing solution may be only one, or two or more.

Such a method of forming the outer part 2 is not limited specifically. Specifically, a method of supplying the processing solution includes one or more kinds of, for example, a coating method, a spray method, etc.

Further, a kind of equipment to be used for the formation of the outer part 2 is not limited specifically. Specifically, the equipment includes, for example, one or more kinds of a high-speed mixer, a spray dry, fluidized-bed granulation coating equipment, etc. In particular, the fluidized-bed granulation coating equipment is preferably rolling-motion fluidized-bed coating equipment, swing-motion fluidized-bed coating equipment, etc. The rolling-motion fluidized-bed granulation coating equipment is equipment that sprays the processing solution onto the surface of the central part 1 with use of a spray nozzle while fluidizing the central part 1 being coated spirally in the inside of a cylindrical rolling-motion fluidized-bed. In this case, wind flows from a lower part to an upper part in the inside of the rolling-motion fluidized-bed, and the central part 1 is thereby rolled upward, which gives a longitudinal motion to the central part 1. In addition, the central part 1 is rotated by rotation of the rotating plate, which gives a horizontal motion to the central part 1. Thereby, the central part 1 is fluidized spirally.

The following advantages are obtained by utilizing the coating principle of the fluidized-bed granulation coating equipment. Firstly, the surface of the central part 1 is coated evenly, which ensures that the outer part 2 is formed in such a manner that a uniform thickness is achieved. Secondly, the coating amount is controlled easily and accurately, and therefore an average thickness of the outer part 2 is strictly controlled. Thirdly, in accordance with the strict control of the average thickness of the outer part 2, dimensions (volumetric average particle size, etc.) of the encapsulated agent are also controlled strictly.

Hence, the expansive material (the central part 1) is provided inside the hollow structure (the outer part 2), bringing the encapsulated agent to completion.

### [1-4. Workings and Effects]

According to the encapsulated agent of the invention, a surface of the central part 1 containing the expansive material is covered with the outer part 2 containing the expansion-inducing material.

In this case, as described above, even if a solution containing the encapsulated agent is used to manufacture the constructional object in which the encapsulated agent is contained (during the pre-breakage period of time), the central part 1 (the expansive material) is covered with the outer part 2. As a result, the expansive material is still unable to expand, and therefore the repairing function of the encapsulated agent is maintained at the time of use of the constructional object in which the encapsulated agent is contained. Meanwhile, when the constructional object in which the encapsulated agent is contained is broken after the start of use of the constructional object (during the post-breakage period of time), the outer part 2 (the expansion-inducing material) induces expansion of the expansive material with respect to a liquid, resulting in expansion of the expansive material. Because this ensures that the encapsulated agent exercises the repairing function, the constructional object is repaired utilizing the repairing function of the encapsulated agent in the proper timing, that is, at the time of breakage of the constructional object. In other words, the outer part 2 brings out the function (expansion of the expansive material) of the central part 1 at the proper timing, by intentionally delaying the function of the central part 1 until breakage of the constructional object.

As a result, the function of the encapsulated agent by the use of the expansibility with respect to a liquid is utilized at the proper timing, which makes it possible to effectively exercise the function of the encapsulated agent.

In particular, if the expansion-inducing material is able to dissolve or swell in a liquid, the encapsulated agent is used in a wide range of applications where there is a possibility of contact with the liquid in the middle of use, which makes it possible to effectively exercise the function of the encapsulated agent in such a wide range of applications.

In this case, if the expansive material contains a water-absorbing clay and/or a water-absorbing polymer compound, and more specifically, contains a bentonite, the expansive material expands necessarily and sufficiently with respect to water, allowing for achievement of more enhanced effects.

Further, if the encapsulated agent is contained in a constructional material to be used for manufacturing of the constructional object, the constructional object is self-repaired utilizing the repairing function of the encapsulated agent in the middle of use (at the time of breakage) of the constructional object. This makes it possible to effectively exercise the repairing function of the encapsulated agent. The details concerning this are described later.

### [2. Application of Encapsulated Agent (Constructional Object)]

Next, the description is provided of an application of the above-described encapsulated agent.

As described above, the application of the encapsulated agent is not specifically limited as long as such an application necessitates repairing to prevent deterioration, etc. of some sort of a constructional object due to breakage of the constructional object in the event of breakage thereof.

In particular, because the encapsulated agent exercises the repairing function taking the opportunity of contact with some sort of a liquid, the application of the constructional object in which the encapsulated agent is contained is preferably an application where there is a possibility that the constructional object will come in contact with a liquid at the time of use.

Here, for example, the description is provided of a case where the encapsulated agent is used in the constructional object for the construction application. The “constructional object” described here is a constructional object that is manufactured with use of a constructional material such as concrete to be described later, and refers to, for example, a house, a building, etc.

### [2-1. Configuration]

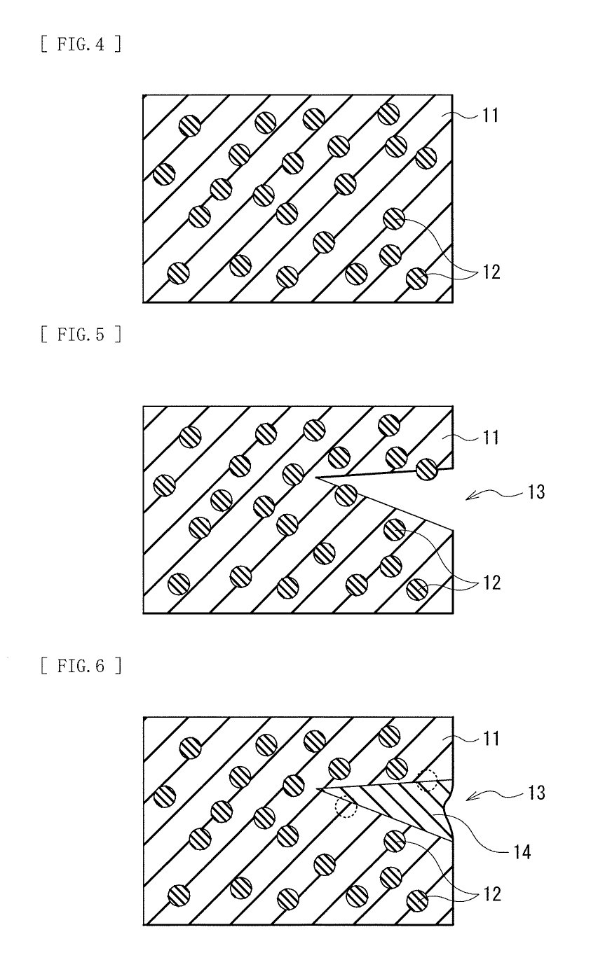

FIG. 4 illustrates a cross-sectional configuration of a constructional object using the encapsulated agent according to the embodiment of the invention. The constructional object includes a constructional material 11, and one or more encapsulated agents 12.

It is to be noted that FIG. 4 illustrates a case where the number of the encapsulated agents 12 is two or more. Further, for simplified illustration purpose, FIG. 4 illustrates a case where a shape of the constructional material is rectangular, and illustrates the encapsulated agents 12 schematically. However, a shape of the constructional object is not limited specifically.

### [Constructional Material]

The construction material 11 is a main ingredient of the constructional object, and includes, for example, one or more kinds of materials to be used typically for manufacturing of the constructional object.

Specifically, the constructional material 11 contains, for example, mortar and/or concrete. The mortar and the concrete are formed by solidifying (curing) a solution containing a cement (a cement liquid), for example.

### [Encapsulated Agent]

The encapsulated agent 12 has a configuration similar to that of the above-described encapsulated agent of the invention. In other words, the encapsulated agent 12 includes the central part 1 containing the expansive material, and the outer part 2 containing the expansion-inducing material, as illustrated in FIGS. 1 and 2.

As described above, the number of the encapsulated agents 12 may be one, or two or more. However, in particular, the number is preferably two or more, and is more preferably sufficiently great. This is because it is easy for the encapsulated agents 12 to exercise the repairing function without depending on a breakage position of the constructional object.

In a case where the number of the encapsulated agents 12 is two or more, the two or more encapsulated agents 12 are preferably dispersed in the constructional material 11. This is because it is easier for the encapsulated agents 12 to exercise the repairing function without depending on a breakage position of the constructional object.

It is to be noted that the content of the encapsulated agent 12 in the constructional material 11 is not limited specifically. However, the content is preferably set to facilitate utilization of the repairing function of the encapsulated agent 12 while assuring the physical characteristics (for example, strength, etc.) of the constructional object.

Specifically, if the content of the encapsulated agent 12 is excessively small, the encapsulated agent 12 is unlikely to exercise the repairing function in the event of breakage of the constructional object, resulting in a decrease in the possibility that the constructional object will be repaired by the encapsulated agent 12. In contrast, if the content of the encapsulated agent 12 is excessively great, a proportion of the constructional material 11 to the constructional object lowers, leading to the possibility of deterioration in the physical characteristics of the constructional object. Therefore, the content of the encapsulated agent 12 is preferably set to ensure both of a high repair probability of the constructional object that is achieved by the encapsulated agent 12, and the physical characteristics of the constructional object.

### [Other Materials]

It is to be noted that the constructional object may further include, for example, one or more kinds of the other materials depending on a kind of the constructional material 11, etc.

The other materials are, for example, a variety of additive agents. Examples of the additive agents to be used in a case where the constructional material 11 is mortar and concrete include a coagulant agent, a fast-curing agent, a curing retardant, a dehydration reducing agent, a dispersing agent, a water reducing agent, a pH adjuster, etc.

Further, the other materials are, for example, other constructional materials (excluding materials corresponding to the constructional material 11). The other constructional materials to be used in a case where the constructional material 11 is concrete are, for example, gravel, reinforcing steel, etc.

### [2-2. Function]

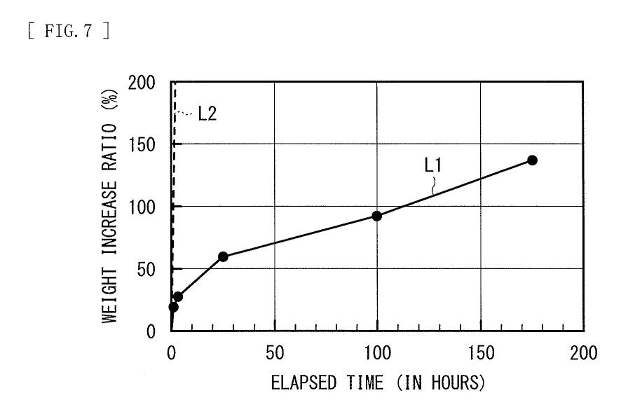

The constructional object functions in the following manner. Each of FIGS. 5 and 6 illustrates a cross-sectional configuration corresponding to FIG. 4 to explain a function of the constructional object.

After manufacturing of the constructional object, the constructional object is installed in an outdoor location, for example. At the time of use of the constructional object (during the pre-breakage period of time), the plurality of encapsulated agents 12 are embedded into the constructional material 11, as illustrated in FIG. 4, and therefore the encapsulated agents 12 are unable to come in contact with a liquid even if there is a possibility that the constructional object will come in contact with the liquid. The liquid that the constructional object is likely to come in contact with includes rainwater, etc., for example. In such a case, because the encapsulated agents 12 are unable to come in contact with the rainwater, etc. even if the constructional object is exposed to the rainwater, etc., the encapsulated agents 12 are still unable to exercise a repairing function. This ensures that the repairing function of the encapsulated agents 12 is maintained during the pre-breakage period of time.

In the middle of use of the constructional object, for example, if the constructional object is subject to external stress, a crack 13 occurs in the vicinity of a surface of the constructional object, as illustrated in FIG. 5, resulting in breakage of the constructional object. Contributing factors that exert the external stress on the constructional object are, for example, drying, water pressure, heat, carbon dioxide, earthquake, etc. In such a case, because some of the encapsulated agents 12 are exposed in the inside of the crack 13, some of the exposed encapsulated agents 12 are able to come in contact with the rainwater, etc., unlike the above-described pre-breakage period of time. It is to be noted that FIG. 5 illustrates a case where the two encapsulated agents 12 are exposed in the inside of the crack 13.

If the encapsulated agent 12 continues to come in contact with the rainwater, etc., the encapsulated agent 12 exercises a function similar to that of the above-described encapsulated agent of the invention (see FIGS. 1 and 3). In other words, for example, in a case where the expansion-inducing phenomenon is dissolution in a liquid, the outer part 2 (the expansion-inducing material) dissolves, resulting in exposure of the central part 1 (the expansive material) that has been covered with the outer part 2 up to that time. This leads to expansion of the expansive material, and therefore the inside of the crack 13 is filled with an expanded substance 14 of the expansive material, as illustrated in FIG. 6.

Hence, the constructional object is self-repaired utilizing the repairing function of the encapsulated agent 12, which prevents the rainwater, etc. from continuing to enter the inside of the crack 13 even if the crack 13 occurs. This prevents the constructional object from being eroded by the rainwater, etc. due to continued ingress of the rainwater, etc. into the inside of the crack 13.

It is to be noted that, as is clear from the above-described principle of the repairing function of the encapsulated agent 12, in a case where the crack 13 occurs in the vicinity of the surface of the constructional object, the capability of self-repairing of the constructional object utilizing the repairing function of the encapsulated agent 12 depends on whether the encapsulated agent 12 is exposed in the inside of the crack 13. Therefore, to enhance the potential for the self-repairing of the constructional object, it is preferable to sufficiently increase the number of the encapsulated agents 12 contained in the constructional material 11, and to sufficiently disperse the encapsulated agents 12 in the constructional material 11.

### [2-3. Workings and Effects]

According to the constructional object of the invention, the constructional object includes the one or more encapsulated agents 12, and the encapsulated agent 12 has a configuration similar to that of the above-described encapsulated agent of the invention. In this case, as described above, the repairing function of the encapsulated agent 12 is maintained at the time of use of the constructional object (during the pre-breakage period of time), and the repairing function of the encapsulated agent 12 is exercised in the event of breakage of the constructional object (during the post-breakage period of time). This allows for self-repairing of breakage of the constructional object utilizing the repairing function of the encapsulated agent 12.

In particular, because the constructional object is typically installed in an outdoor location, the encapsulated agent 12 exercises the repairing function utilizing the expansibility with respect to rainwater, etc., thereby making it possible to effectively prevent progression of structural deterioration (erosion) in the constructional object that is caused due to the rainwater, etc.

Any other workings and effects concerning the constructional object are similar to the workings and effects of the encapsulated agent according to the embodiment of the invention.

It is to be noted that a case where the encapsulated agent is used in the constructional object (for example, a building, etc.) for the construction application is here taken as an example; however, a kind of the constructional object in which the encapsulated agent is used is not specifically limited, as described above. The constructional objects intended for applications other than the construction application are, for example, constructional objects for the shore protection work application (for example, a tetrapod, a breakwater, etc.), or any other equivalent constructional objects. Further, the constructional objects intended for any other applications are, for example, a tunnel, a road, a dam, a well, etc., and examples of the well include a water well, an oil well, a gas well, a geothermal well, a steam well, etc. In addition, the encapsulated agent may be used as, for example, a filler (a lost circulation inhibitor) for a crack arising on a drilling wall in excavating a well.

### WORKING EXAMPLES

Hereinafter, the description is provided of working examples of the invention. The order of descriptions is as follows. However, the embodiments of the invention are not limited to the embodiments to be described here.

### 1. Manufacturing of Encapsulated Agent, etc.

### 2. Evaluation of Encapsulated Agent, etc.

### [1. Manufacturing of Encapsulated Agent, etc.]

### Experimental Example 1

The encapsulated agent (see FIG. 1) that utilizes swelling with respect to water as the expansion-inducing phenomenon was manufactured in the following procedures.

In the first place, a water-based emulsion solution containing the expansion-inducing material (SBR resin) (carboxy-modified styrene-butadiene copolymer NALSTAR-SR-107 available from NIPPON A&L INC) was prepared. Next, the processing solution (concentration of solid content: 8%) was prepared by diluting the water-based emulsion solution with use of a solvent (ethanol).

Thereafter, the expansive material (sodium bentonite) was granulated using a method described in Japanese Unexamined Patent Application Publication No. H10-137581, and the central part 1 (a volumetric average particle size: 568 μm) was thereby obtained.

Next, the outer part 2 was formed by spraying the processing solution onto a surface of the central part 1 using rolling-motion fluidized-bed coating equipment (type LABO available from Freund Corporation), and thereafter drying the processing solution.

In the above-described procedures, the central part 1 containing the expansive material was covered with the outer part 2 containing the expansion-inducing material, thereby bringing the encapsulated agent (the volumetric average particle size: 586 μm) to completion.

### Experimental Example 2

With the exception that the outer part 2 was not formed for comparison, a non-encapsulated agent (the central part 1) was obtained using procedures similar to those in the above-described experimental example 1.

It is to be noted that a configuration of each of the encapsulated agent and the non-encapsulated agent is as represented in Table 1.

TABLE 1

| | Central part | Outer part | Volumetric |
|---|---|---|---|
| Experimental | (expansive | (expansion-inducing | average |
| examples | material) | material) | particle size (μm) |
| 1 | Sodium | SBR resin | 586 |
| (encapsulated | bentonite | | |
| agent) | | | |
| 2 | Sodium | — | 568 |
| (non-encapsulated | bentonite | | |
| agent) | | | |

### [2. Evaluation of Encapsulated Agent, etc.]

For simplified evaluation of the performance (the repairing function) of the encapsulated agent, etc., the encapsulated agent, etc. of 10 grams were put in hot water (temperature: 75 degrees centigrade), and thereafter weight variation of the encapsulated agent, etc. was tracked, thereby obtaining a result illustrated in FIG. 7. It is to be noted that the hot water was used without using cold water because a so-called accelerated test was performed utilizing a tendency that the use of the hot water facilitates swelling of the outer part 2 (the expansion-inducing material).

FIG. 7 illustrates a correlation between a weight increase ratio of the encapsulated agent, etc. and an elapsed time. In other words, a horizontal scale denotes the elapsed time (on an hourly basis) after putting the encapsulated agent, etc. into hot water, and a vertical scale denotes a weight increase ratio (%) of the encapsulated agent, etc. that is calculated from Expression (1) given below.

Weight increase ratio (%)=[(weight after putting encapsulated agent, etc.−weight before putting encapsulated agent, etc.)/weight before putting encapsulated agent, etc.]×100 (1)

It is to be noted that, in FIG. 7, a solid line L1 corresponds to the experimental example 1 (the encapsulated agent), and a dashed line L2 corresponds to the experimental example 2 (the non-encapsulated agent).

As seen from Table 1 and FIG. 7, a situation where the repairing function of the encapsulated agent, etc. was exercised varied significantly depending on a configuration of each of the encapsulated agent, etc.

Specifically, in a case where the non-encapsulated agent in which the central part 1 was not covered with the outer part 2 was used (the experimental example 2, the dashed line L2), when the non-encapsulated agent was put in the hot water, the weight increase ratio increased rapidly in a short amount of time. More specifically, the weight increase ratio exceeded 200% a great deal in only about several dozen minutes.

This result indicates that, because the central part 1 (the expansive material) was not covered with the outer part 2, and the central part 1 was exposed, the expansive material began to expand immediately after the non-encapsulated agent was put in the hot water.

In such a case, for example, when a cement liquid containing the encapsulated agent is prepared to manufacture a constructional object (for example, concrete) that contains the encapsulated agent therein, the central part 1 (the expansive material) has already come in contact with water sufficiently in the cement liquid, resulting in unintentional expansion of the expansive material. This makes it impossible to maintain the repairing function of the encapsulated agent until breakage of the concrete after manufacturing of the concrete.

In contrast, in a case where the encapsulated agent in which the central part 1 was covered with the outer part 2 was used (the experimental example 1, the solid line L1), when the encapsulated agent was put in the hot water, the weight increase ratio increased gradually over time. More specifically, the weight increase ratio increased up to about 140% gradually after the elapse of about 175 hours.

This result indicates that, because the central part 1 (the expansive material) was covered with the outer part 2, and the central part 1 was not exposed, when the encapsulated agent was put in the hot water, the expansive material expanded gradually as the outer part 2 (the expansion-inducing material) expanded.

In such a case, for example, even if the cement liquid containing the encapsulated agent is prepared, the expansive material does not yet expand in the cement liquid, and therefore the repairing function of the encapsulated agent is maintained. As a result, even if the encapsulated agent is contained in the cement liquid, the encapsulated agent has no adverse influence on a manufacturing process of the concrete using the cement liquid.

In addition, after manufacturing of the concrete, if the encapsulated agent comes in contact with rainwater, etc. sufficiently due to occurrence of a crack in the middle of use (at the time of breakage) of the concrete, the central part 1 (the expansive material) comes in contact with the rainwater, etc. sufficiently in accordance with swelling of the outer part 2 (the expansion-inducing material), and therefore the expansive material expands gradually to fill the crack. It is seen from a gradual slope of the solid line L1 illustrated in FIG. 7 that the expansive material expands gradually without expanding rapidly over time in such a manner. Hence, the repairing function of the encapsulated agent is exercised at the time of breakage of the concrete after manufacturing of the concrete, which allows for self-repairing of the breakage of the concrete utilizing the repairing function of the encapsulated agent.

It is to be noted that, because the outer part 2 swells over time even if the encapsulated agent is used, supposedly, the encapsulated agent is likely to exercise the repairing function unintentionally in the cement liquid, as was expected.

However, according to observation of a transition of the weight increase ratio of the encapsulated agent, the weight increase ratio of the encapsulated agent increases up to about 140% after the elapse of a long time of about 175 hours (about 7 days), as described above. Hence, in manufacturing the concrete with use of the cement liquid containing the encapsulated agent, if the encapsulated agent is designed to ensure that the weight increase ratio is suppressed sufficiently within a period of time necessary for drying the cement liquid, it is possible to maintain the repairing function of the encapsulated agent in a manufacturing state of the concrete. It is to be noted that, to design the encapsulated agent in the above-described manner, for example, a formation material (a kind of the expansion-inducing material), an average thickness, etc. of the outer part 2 may be adjusted.

On the basis of these results, the use of the encapsulated agent in which the central part containing the expansive material was covered with the outer part containing the expansion-inducing material made it possible to effectively exercise the function utilizing the expansibility with respect to a liquid.

The invention is described thus far with reference to the embodiments and the working examples; however, the invention is not limited to the aspects described in the embodiments and the working examples, but various modifications may be made.

Specifically, the application of the encapsulated agent is not limited to the constructional objects for the above-described applications, and the encapsulated agent may be applied to constructional objects for any other applications. Even in such a case, if the application necessitates bringing out the function utilizing the expansibility with respect to a liquid in the middle of use of the constructional object, it is possible to obtain similar effects. Further, it is not necessitated that the encapsulated agent is preliminarily contained in the constructional object at the time of completion of the constructional object, and the encapsulated agent may be introduced into the constructional object in an ex-post manner after completion of the constructional object.

This application claims the priority on the basis of Japanese Patent Application No. 2015-167126 filed on Aug. 26, 2015 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1-6. (canceled)

7. An encapsulated agent comprising:
a central part containing a material that is expansive with respect to a liquid; and
an outer part that covers a surface of the central part, and contains a material with a capability to induce expansion of the central part with respect to the liquid,
the material that is able to induce the expansion of the central part including one or more kinds of a copolymer of styrene and butadiene (SBR resin), a copolymer of acrylonitrile, butadiene, and styrene (ABS resin), a copolymer of acrylonitrile and styrene (AS resin), polyethylene, polypropylene, polystyrene, a polyalkylene oxide, polyalkylene glycol, polyvinyl alcohol, vinyl chloride resin, methacyl resin, acrylic resin, polyacrylamide, polyamide, polycarbonate, polyacetal, polyester, polyphenylene ether, phenol resin, epoxy resin, melamine resin, urea resin, alkyd resin, polyurethane resin, polytetrafluoroethylene (PTFE), a copolymer of tetrafluoroethylene and perfluoroalkyl vinyl ether (PFA), a copolymer of tetrafluoroethylene and hexafluoropropylene (FEP), a copolymer of tetrafluoroethylene and ethylene (ETFE), polyvinylidene fluoride (PVDF), polychlorotrifluoroethylene (PCTFE), a copolymer of chlorotrifluoroethylene and ethylene (ECTFE), silicone resin, polydimethylsiloxane, and a modified substance of any of the above materials.

8. The encapsulated agent according to claim 7, wherein the material that is expansive with respect to the liquid includes water-absorbing viscosity.

9. The encapsulated agent according to claim 7, wherein the encapsulated agent is contained in a constructional material to be used in manufacturing of a constructional object.

10. A constructional object comprising:
a constructional material; and
one or more encapsulated agents each of which includes a central part and an outer part, the central part containing a material that is expansive with respect to a liquid, the outer part covering a surface of the central part, and containing a material with a capability to induce expansion of the central part with respect to the liquid,
the material that is able to induce expansion of the central part including one or more kinds of a copolymer of styrene and butadiene (SBR resin), a copolymer of acrylonitrile, butadiene, and styrene (ABS resin), a copolymer of acrylonitrile and styrene (AS resin), polyethylene, polypropylene, polystyrene, a polyalkylene oxide, polyalkylene glycol, polyvinyl alcohol, vinyl chloride resin, methacyl resin, acrylic resin, polyacrylamide, polyamide, polycarbonate, polyacetal, polyester, polyphenylene ether, phenol resin, epoxy resin, melamine resin, urea resin, alkyd resin, polyurethane resin, polytetrafluoroethylene (PTFE), a copolymer of tetrafluoroethylene and perfluoroalkyl vinyl ether (PFA), a copolymer of tetrafluoroethylene and hexafluoropropylene (FEP), a copolymer of tetrafluoroethylene and ethylene (ETFE), polyvinylidene fluoride (PVDF), polychlorotrifluoroethylene (PCTFE), a copolymer of chlorotrifluoroethylene and ethylene (ECTFE), silicone resin, polydimethylsiloxane, and a modified substance of any of the above materials.

11. The constructional object according to claim 10, wherein the material that is expansive with respect to the liquid includes water-absorbing viscosity.

12. The constructional object according to claim 10, wherein the constructional material contains one or both of mortar and concrete.
